(19) United States
(12) Patent Application Publication
(10) Pub. No.: US 2008/0246617 A1
(43) Pub. Date: Oct. 9, 2008

(54) MONITOR APPARATUS, SYSTEM AND METHOD

(75) Inventors: Teh Ho Tao, Hsinchu City (TW); Shih Jen Hu, Tainan County (TW); Su Chen Kuo, Miaoli County (TW); Horng Shing Lu, Hsinchu City (TW); Tai Been Chen, Hsinchu City (TW)

Correspondence Address: WPAT, PC;INTELLECTUAL PROPERTY ATTORNEYS, 2030 MAIN STREET, SUITE 1300, IRVINE, CA, 92614, US

(73) Assignee: INDUSTRIAL TECHNOLOGY RESEARCH INSTITUTE, Hsinchu County (TW)

(21) Appl. No.: 11/840,405

(22) Filed: Aug. 17, 2007

(30) Foreign Application Priority Data
Apr. 4, 2007 (TW) 096111935

(51) Int. Cl. G08B 23/00

(52) U.S. Cl. 340/573.1

(57) ABSTRACT

An apparatus, system and method which use a portable sensor to monitor the physical and mental reactions of a person in motion. The physical and mental reactions in motion will be transformed into the related physical and mental characteristic vectors, which are used to build up a personalized physical and mental database. The database executes a self-learning algorithm to output a set of physical and mental weighting factors. After executing the set of physical and mental weighting factors and physical and mental characteristic vectors, an embedded calculator incorporated in the portable sensor gives a warning signal if an abnormal situation is detected.

### BACKGROUND OF THE INVENTION

1. Field of the Invention

The present invention relates to a monitor apparatus, system and method, and more particularly, to a monitor apparatus, system and method which set up a self-learning database in a remote computer and only use a simple portable device having a basic calculation function to predict a physical and mental status of subject.

2. Description of the Related Art

Traditional patient monitors only focus on a user's physical status but exclude his or her mental status, such as U.S. Pat. No. 6,322,515 and U.S. Pat. No. 6,338,713. Nowadays, there are different ways to sense people's physical and mental status with a computer, such as by blood pressure, pulsation, blood flow, blood sugar level, body temperature, breath rate or brain wave. U.S. Pat. No. 4,100,536 discloses a method displaying a user's stress level by detecting one's heartbeat rates. However, this method is too simple to effectively reflect one's feeling. With respect to the detection of mental status, it is generally agreed that the brain activities are directly related. Given the above, U.S. Pat. No. 6,129,681 discloses a method detecting the mental status reflected by brain wave variance. However, the brain wave is weak and easy to be disturbed by the outside environment; therefore such a method is only suitable for the use of the experimental research rather than regular operations. U.S. Pat. No. 6,656,116 discloses a method which estimates the status of one's feeling by means of measuring physical parameters. However, that method makes classifications with different thresholds, so the application of such a method on different users is difficult. U.S. Pat. No. 6,520,905 discloses a classification with personalized thresholds for evaluating physical and mental status. However, such a method requires a lot of computing resources due to its complex structure. U.S. Pat. No. 6,904,408 discloses another classification with personalized thresholds for the assessment of physical and mental status, mainly by means the assessment of neural network method. Similarly, such a method requires a lot of computing resources. In addition, there are other methods, which use facial expression and vocal tone identification for analysis. But those methods are not mature enough. For example, U.S. Pat. No. 5,647,834 uses vocal tone to determine the status of the person under assessment. However, that method is slow due to a lot of complex computing required, and therefore it is difficult to be applied practically.

A lot of accidents occur around us in daily life. In some physical abnormalities, such as cardiac arrhythmia and hypertension, may be monitored by some wearable physical monitoring devices, like the 24-hour Holter electrocardiogram or continuous blood pressure meter. Subsequently the result is interpreted by professionals and used in diagnosis and treatment. However, some abnormalities are difficult to distinguish when they happen, and sometimes they are hard to detect by using traditional patient monitor without incorporating mental factors. Feelings such as nervousness, happiness, anger, fear or shame will result in people's physical reactions, such as the level of blood pressure and blood sugar, pulsation, blood flow, body temperature, etc. Therefore, by observing said physical factors, one's mental situation can be inferred. However, the variance of physical and mental reactions depends on a variety of factors, such as personal experiences. As such, traditional classifications are most likely unable to meet the various demands on a personal basis. In addition, a good classification algorithm must possess the self-learning capability to fit different people. Also, to reduce inconvenience for users in motion and avoid discomfort to users who have the need to wear the sensors for a long time, the sensors must be carefully selected.

### SUMMARY OF THE INVENTION

The present invention proposes an apparatus, system and method, which use a portable sensor to monitor the physical and mental reactions of a user in motion. The apparatus needs not a powerful computing function because most of the works are easy. Generally speaking, most of the works are done by an embedded processing unit, which detects whether or not an abnormality occurs. And if so, an alarm is triggered. A personalized physical and mental database is built in a remote computer. After being synchronized with the processing unit, the database receives updated physical and mental characteristic vectors from the embedded processing unit. By statistical classifications, physical and mental weighting factors are calculated and returned to the processing unit after a time period. No matter used on-line or off-line, after synchronization, the processing unit uses the updated parameters to do more precise predictions on the physical and mental conditions. Because the personalized physical and mental database can be updated continuously, self-learning and long-term tracing effects are achieved.

The monitor apparatus according to an embodiment of the present invention includes a portable device and a processing unit. The portable device is configured to sample physical and mental signals from the user. The processing unit calculates the physical and mental characteristic vectors with the sampled physical and mental signals, and determines whether the user is in a normal physical and mental status according to the physical and mental weighting factors and characteristic vectors.

The monitor apparatus according to an embodiment of the present invention includes a portable device, a transceiver, a weighting factor register, a vector calculator and a physical and mental calculator. The portable device is configured to sample physical and mental signals from a user. The transceiver is configured to receive and update physical and mental weighting factors of a remote database. The weighting factor register is in use for storing the physical and mental weighting factors received from the transceiver. The vector calculator is in use for calculating physical and mental characteristic vectors with the sampled physical and mental signals. The physical and mental calculator is configured to calculate the physical and mental classification according to the physical and mental weighting factors and characteristic vectors.

The monitor system according to an embodiment of the present invention includes a remote computer and a monitor apparatus. The remote computer has a physical and mental database so as to generate physical and mental weighting factors. The monitor apparatus is configured to sample and calculate physical and mental characteristic vectors, and calculates a physical and mental status with the physical and mental weighting factors and characteristic vectors, wherein the monitor apparatus warns if the physical and mental status is classified as abnormality. The monitor apparatus updates the physical and mental database with the abnormal data in a specific period.

The monitor method according to an embodiment of the present invention includes the step of obtaining physical and mental weighting factors of a specific user from a remote physical and mental database. Thereafter, physical and mental samples are taken from the user and physical and mental characteristic vectors are calculated. In addition, physical and mental classification is calculated with the physical and mental weighting factors and characteristic vectors. Next, if the physical and mental classification is regarded as abnormality, an alarm is triggered.

The monitor method according to an embodiment of the present invention includes the step of generating physical and mental weighting factors of a specific user from a physical and mental database of a remote computer. Thereafter, physical and mental characteristic vectors are obtained through a portable device. A physical and mental classification with the physical and mental weighting factors and characteristic vectors is performed.

### BRIEF DESCRIPTION OF THE DRAWINGS

The invention will be described according to the appended drawings in which:

FIG. 1 shows a physical and mental monitor system according to an embodiment of the present invention;

FIG. 2 shows a hint diagram of a physical and mental monitor system according to the present invention;

FIG. 3 shows a hint diagram of the physical and mental apparatus according to the present invention;

FIG. 4 exemplifies a classification of a support vector machine;

FIG. 5 shows the classifications of SVM; and

FIG. 6 is a flow chart of the physical and mental monitor method of the present invention.

### PREFERRED EMBODIMENT OF THE PRESENT INVENTION

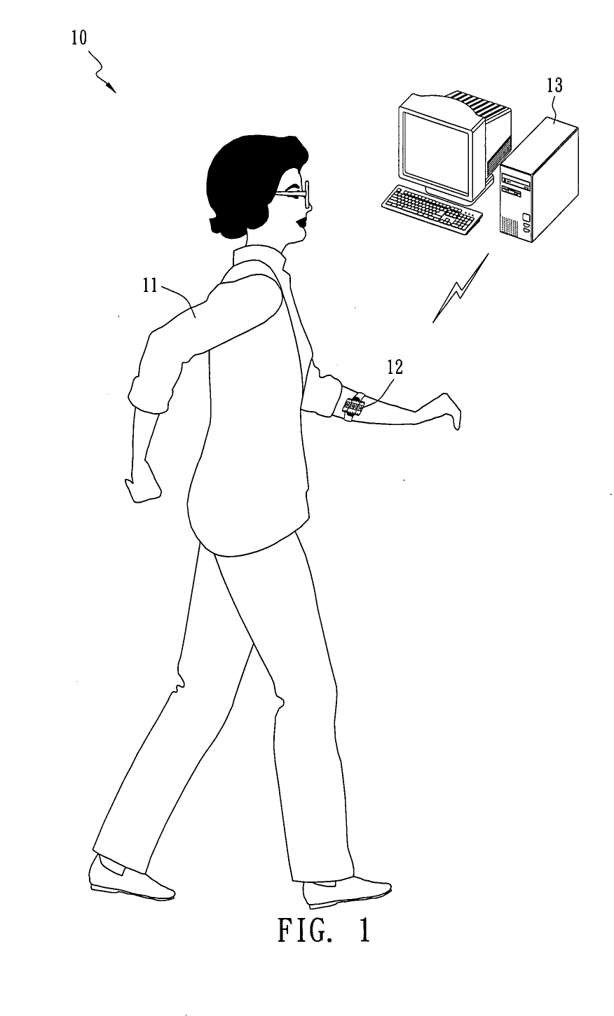

FIG. 1 shows a physical and mental monitor system 10 according to an embodiment of the present invention. The system 10 includes a physical and mental apparatus 12 and a remote computer 13. The remote computer 13 stores the physical and mental database of a user 11 in advance. The physical and mental database possesses a self-learning function, which can update its content with the data of abnormalities transmitted back from the physical and mental monitor apparatus 12. The physical and mental monitor apparatus 12 captures physical and mental samples from the user 11 and determines if an abnormal situation occurs. The capture can be done in an ultra-wide band non-contact operating mode, which measures the phase shift between a reflected and a reference high-frequency pulse sequence. Because the phase shift signal is proportional to the physical and mental status, it could be used to represent physical and mental samples.

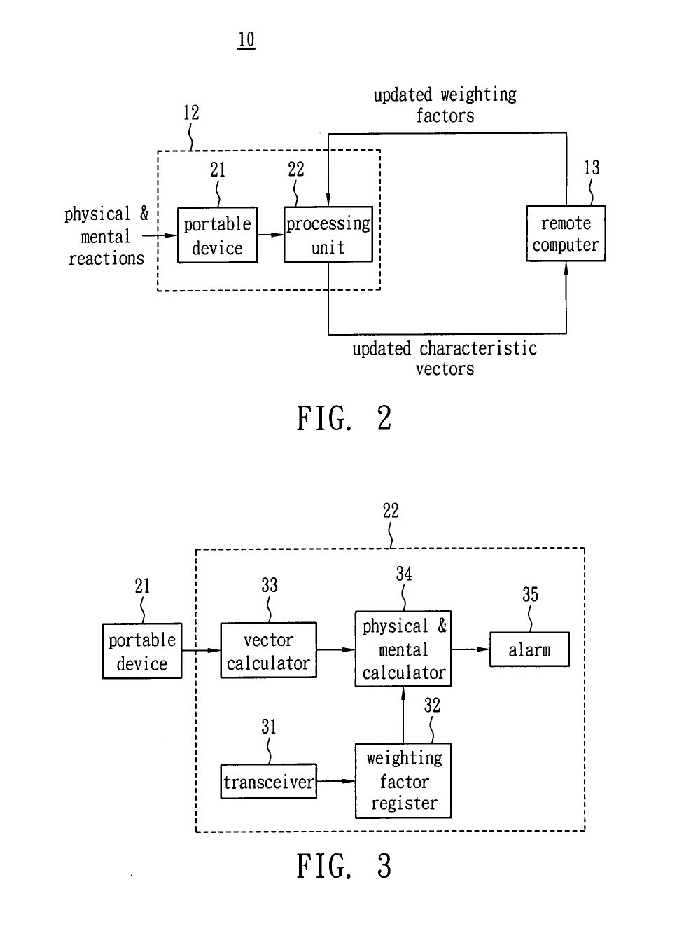

FIG. 2 shows a hint diagram of a physical and mental monitor system according to the present invention. The physical and mental monitor system 10 uses a monitor apparatus 12, such as a portable device 21 plus a processing unit 22, which has a small size and a basic calculation function, to capture physical and mental samples of a user 11, such as breath rate, cardiac status reflected by the pulsation or blood pressure. The physical and mental monitor apparatus 12 uses the captured physical and mental samples to calculate physical and mental characteristic vectors. Thereafter, the physical and mental monitor apparatus 12 calculates a physical and mental classification of the user 11 with the physical and mental weighting factors and characteristic vectors forwarded by the remote computer 13. If the physical and mental status of the user is determined as abnormal, then the alarm of the physical and mental monitor apparatus 12 will be triggered and data will be collected. Said data obtained from the physical and mental monitor apparatus 12 will update the physical and mental database of the remote computer 13 in a given timeframe. The physical and mental weighting factors and characteristic vectors can be updated off-line so as to reduce power consumption of the physical and mental apparatus 12 and unnecessary signal transmissions. Also, the physical and mental characteristic vectors can be updated by only capturing the data of abnormalities so as to save the space of the physical and mental database.

FIG. 3 shows a hint diagram of the physical and mental apparatus 12 according to the present invention. The physical and mental apparatus 12 includes a portable device 21 and a processing unit 22. The processing unit 22 includes a transceiver 31, a weighting factor register 32, a vector calculator 33, a physical and mental calculator 34 and an alarm 35. The transceiver 31 is in use for receiving and updating the physical and mental weighting factors of a remote database. The weighting factor register 32 is in use for storing the physical and mental weighting factors received from the transceiver 31. The vector calculator 33 is in use for taking physical and mental samples from the user 11 in motion, such as physical signals with respect to cardiac status, and based on such samples to calculate the physical and mental characteristic vectors of the user. The physical and mental calculator 34 performs the physical and mental classification based on the physical and mental weighting factors and characteristic vectors. Because such calculation needs only a basic computing device to perform the physical and mental classification, a processing unit 22 having basic computing function would suffice. The physical and mental status of the user detected that apparently diverges from the baseline will be classified as an abnormality, and the alarm 35 is thus triggered.

According to one embodiment of the present invention, the remote computer 13 has the physical and mental database of the user 11, which stores 30 items of the physical and mental characteristic vectors of the user in advance and thus analyzes the physical and mental weighting factors. The physical and mental factors include Ŵ₀, Ŵ₁ and Ŵ₂, wherein Ŵ₀ includes {W_{0,1},W_{0,2}, . . . ,W_{0,18}}, Ŵ₁ includes {W_{1,1},W_{1,2}, . . . ,W_{1,18}} and Ŵ₂ includes {W_{2,1},W_{2,2}, . . . ,W_{2,18}}. All the data from W₀₁ to W_{2,18} are calculated according to the 30 items of physical and mental characteristic vectors. The physical and mental characteristic vector \hat{T}₃₁ includes {T_{31,1},T_{31,2}, . . . ,T_{31,18}}, wherein each element represents one different characteristic. For example, T_{31,1} represents a mean of captured samples, T_{31,2} represents a standard deviation of the captured samples, T_{31,8} represents a low-frequency power spectrum, T_{31,10} represents a high-frequency power spectrum. The physical and mental classifications W₀, W₁, W₂ calculated by the physical and mental apparatus 12 are as follows:

W₀=\hat{W}₀×\hat{T₃₁^{T}}+W_{0.19}, W₁=\hat{W}₁×\hat{T₃₁^{T}}+W_{1.19}, W₂=\hat{W}₂×\hat{T₃₁^{T}}+W_{2.19},

respectively, where W_{0,19}, W_{1,19} and W_{2,19} are constants calculated from the physical and mental database. The physical and mental database of the remote computer 13 is established according to different adaptive classifications of individual persons. For example, table 1 is an experimental result, in which the statistical classifications involving six databases apply. The result shows that the classification model applying to the physical and mental data is reasonably accurate (>=75%).

TABLE 1

| | | |
|---|---|---|
| | Accuracy | |
| | accumulated from | |
| Database | 30 items | Physical and mental |

| algorithm | Total | In detail | status |
|---|---|---|---|
| Bayes network | 93.05% | 100.00% | Neutrality |
| | | 79.20% | Anger |
| | | 100.00% | Happiness |
| Naïve Bayes | 94.44% | 100.00% | Neutrality |
| | | 87.50% | Anger |
| | | 95.80% | Happiness |
| SVM | 97.22% | 100.00% | Neutrality |
| | | 95.80% | Anger |
| | | 95.80% | Happiness |
| C4.5 | 75.00% | 79.20% | Neutrality |
| | | 79.20% | Anger |
| | | 66.70% | Happiness |
| Logistic Model | 98.61% | 100.00% | Neutrality |
| | | 95.80% | Anger |
| | | 100.00% | Happiness |
| KNN | 93.05% | 100.00% | Neutrality |
| | | 83.30% | Anger |
| | | 95.80% | Happiness |

The present invention selects a best prediction model first by means of a physical and mental database set up at first so as to determine the best physical variance prediction model. The classification is set up for specific users instead of referring to external clinic data. Because external clinic data come from people having different sex, age and physical characters, the use of such a database is inaccurate and inconvenient. In addition, physical signals of specific individuals are easily disturbed due to the variance of the external clinic data. In contrast to the prior art, the present invention is especially designed for individuals, and selects the best accurate prediction model, including parameter estimate and personalized prediction on a personal basis. The present invention can accumulate some data of abnormalities within a given timeframe and then feedback to the database to revise the model, and estimate physical and mental weighting factors. Therefore, the statistic model of the present invention possesses features such as adjusting itself with the time and variance of the physical parameters.

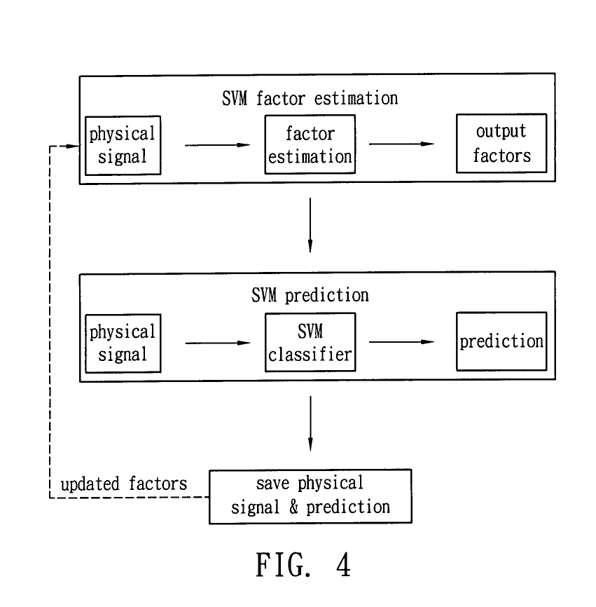

FIG. 4 is exemplified by a classification of a support vector machine (SVM), which illustrates how to apply SVM classification to the process of user's physical signals and the prediction of the physical and mental status. The formula of SVM classification is shown in equation (1).

$$x = β + {\sum }_{i} {α}_{i} {y}_{i} {\vec{a}}_{i} \cdot {\vec{a}}_{i} \qquad ( 1 )$$

The parameter β of the equation (1) is a constant, αᵢ is a weighting factor, yᵢ is an i-th real value. In this example, the real value is RRI, \vec{α}ᵢ is an i-th support vector, x is a fraction of the i-th support vector, which represents the physical status in this example. A linear function can be used as a training SVM model of this example.

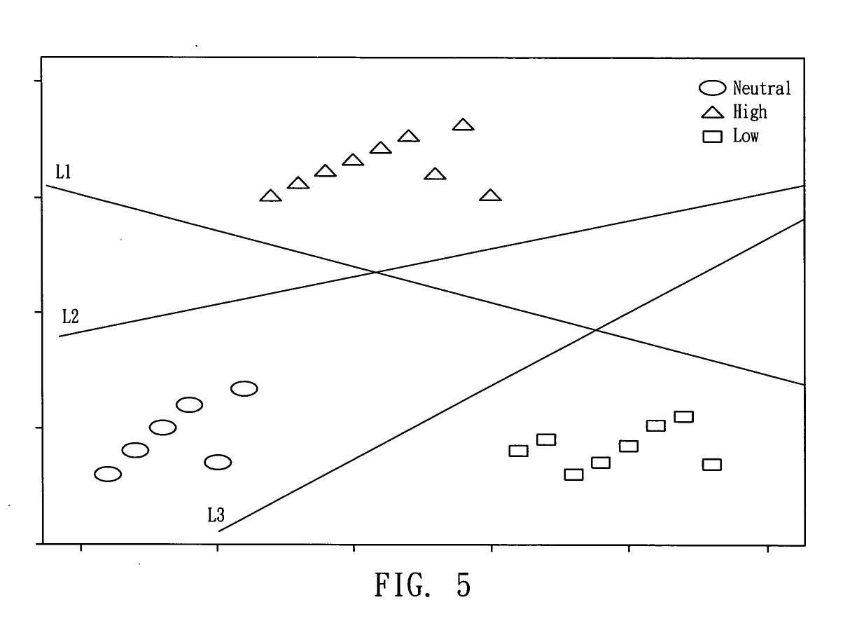

FIG. 5 further shows the classification of SVM, where a line L1 is between the “high” and “low” regions, a line L2 is between the “high” and “neutral” regions, and a line L3 is between the “neutral” and “low” regions. By means of the lines L1, L2 and L3 and the use of the “high,” “neutral” or “low” regions, the physical and mental status of a user can be easily identified.

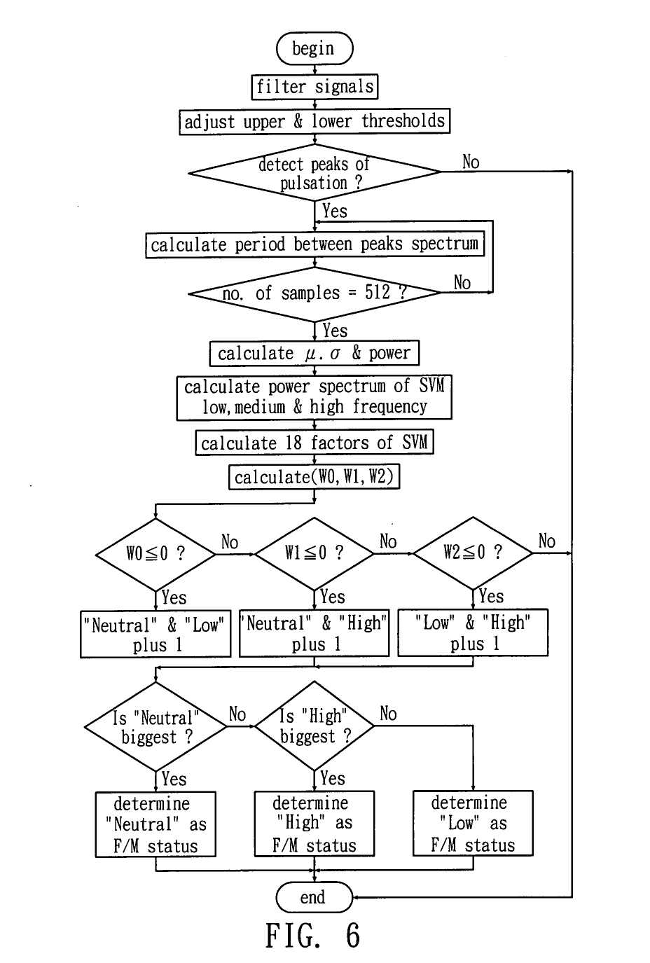

FIG. 6 is a flow chart of the physical and mental monitor method of the present invention. The digital signals of the present invention are filtered for the exclusion of unnecessary noises first through a band pass filter. Thereafter, the filtered digital signals are used to adjust the upper and lower thresholds of the pulsation. If a peak of the pulsation is detected, the system will calculate the time difference between this and the last peaks, i.e., the RRI period of the pulsation, which is stored in a memory buffer region finally. If the memory buffer stores 512 items of the pulsation period data, the system will calculate their mean, standard deviation, the RRI power spectrum, etc. The present invention uses the calculated power spectrum to further calculate the low-frequency, medium frequency and high-frequency power spectrums of the SVM. The above-calculated parameters can be used to analyze 18 physical and mental characteristic vectors \hat{T}₃₁={T_{31,1},T_{31,2}, . . . ,T_{31,18}}. The 18 physical and mental characteristic vectors have corresponding physical and mental weighting factors Ŵ₀={W_{0,1},W_{0,2}, . . . ,W_{0,18}}, Ŵ₁={W_{1,1},W_{1,2}, . . . ,W_{1,18}} and Ŵ₂={W_{2,1},W_{2,2}, . . . ,W_{2,18}}. Through a matrix multiplication and adjustment, three physical and mental classifications W₀, W₁ and W₂ are obtained, where W₀=Ŵ₀×\hat{T}\hat{T₃₁^{T}}+W_{0,19}, W₁=Ŵ₁×\hat{T}\hat{T₃₁^{T}}+W_{1,19} and W₂=Ŵ₂×\hat{T}\hat{T₃₁^{T}}+W_{2,19}. If W₀ is smaller than or equal to zero, the “neutral” and “low” physical and mental pointers are added by one. If W₁ is smaller than or equal to zero, the “neutral” and “high” physical and mental pointers are added by one. If W₂ is smaller or equal to zero, the “high” and “low” physical and mental pointers are added by one. After calculating the physical and mental pointers, the system compares the value of each of the physical and mental pointers. The physical and mental pointer having the greatest value indicates the physical and mental status of the user, which can be described as “neutral,” “high” or “low”.

As far as the mobile sensor is concerned, the embodiment of the present invention adopts an ultra-wide band non-contact sensor, which can be manufactured as a wearable one, to detect the cardiac status reflected by the pulsation of the user. Such a kind of sensor can be placed on anywhere of a human body where the pulsation of an artery is reflected, despite being separated by clothing. Therefore, the user's inconvenience can be reduced to the minimum.

The above-described embodiments of the present invention are intended to be illustrative only. Numerous alternative embodiments may be devised by person skilled in the art without departing from the scope of the following claims.

What is claimed is:

1. A monitor apparatus capturing physical and mental weighting factors of a user from a physical and mental database of a remote computer, the monitor apparatus comprising:
a portable device configured to sample physical and mental signals from the user; and
a processing unit calculating physical and mental characteristic vectors with the sampled physical and mental signals, the processing unit determining whether the user is in a normal physical and mental status according to the physical and mental weighting factors and characteristic vectors.

2. The monitor apparatus of claim 1, wherein the portable device is operated in a non-contact ultra-wide band mode.

3. The monitor apparatus of claim 1, wherein the portable device is samples the breath rate of the user.

4. The monitor apparatus of claim 1, wherein the portable device samples the cardiac status reflected by the pulsation of the user.

5. The monitor apparatus of claim 1, wherein the portable device samples the blood pressure of the user.

6. The monitor apparatus of claim 1, wherein the processing unit updates the physical and mental database with obtained abnormal data.

7. The monitor apparatus of claim 6, wherein the update is done in an off-line manner.

8. A monitor apparatus, comprising:
a portable device configured to sample physical and mental signals from a user;
a transceiver configured to receive and update physical and mental weighting factors of a remote database;
a weighting factor register for storing the physical and mental weighting factors received from the transceiver;
a vector calculator for calculating physical and mental characteristic vectors with the sampled physical and mental signals; and
a physical and mental calculator configured to perform the physical and mental classification according to the physical and mental weighting factors and characteristic vectors.

9. The monitor apparatus of claim 8, wherein the portable device is operated in a non-contact ultra-wide band mode.

10. The monitor apparatus of claim 8, further comprising an alarm, which yields a warning if the physical and mental classification is abnormal.

11. The monitor apparatus of claim 8, wherein the portable device samples the breath rate of the user.

12. The monitor apparatus of claim 8, wherein the portable device samples the cardiac status of the pulsation of the user.

13. The monitor apparatus of claim 8, wherein the portable device samples the blood pressure of the user.

14. The monitor apparatus of claim 10, wherein the remote database is updated with the abnormal data in an off-line manner.

15. The monitor apparatus of claim 8, wherein the physical and mental calculator comprises:
means for performing a matrix multiplication between the physical and mental weighting factors and characteristic vectors and an addition by a constant to obtain three physical and mental classifications W₀, W₁ and W₂;
means for adding neutral and low physical and mental indices by one if W₀ is smaller or equal to zero;
means for adding neutral and high physical and mental indices by one if W₁ is smaller or equal to zero;
means for adding high and low physical and mental indices by one if W₂ is smaller or equal to zero; and
means for determining the physical and mental index having the greatest value as the physical and mental status.

16. A monitor system comprising:
a remote computer having a physical and mental database so as to generate physical and mental weighting factors; and
a monitor apparatus configured to sample and calculate physical and mental characteristic vectors, the monitor apparatus calculating a physical and mental status with the physical and mental weighting factors and characteristic vectors, wherein the monitor apparatus warns if the physical is and mental status is classified as abnormality;
wherein the monitor apparatus updates the physical and mental database with the abnormal data in a specific period.

17. The monitor system of claim 16, wherein the monitor apparatus is operated in a non-contact ultra-wide band mode.

18. The monitor system of claim 16, wherein the portable device samples the breath rate of a user.

19. The monitor system of claim 16, wherein the portable device samples the cardiac status of the pulsation of a user.

20. The monitor system of claim 16, wherein the portable device samples the blood pressure of a user.

21. The monitor system of claim 16, wherein the physical and mental database stores the physical and mental characteristic vectors before the monitor apparatus operates.

22. The monitor system of claim 21, wherein the physical and mental database of the remote computer stores only the physical and mental characteristic vectors.

23. A monitor method, comprising the steps of:
obtaining physical and mental weighting factors of a specific user from a remote physical and mental database;
taking physical and mental samples from the user and calculating physical and mental characteristic vectors;
calculating physical and mental classification with the physical and mental weighting factors and characteristic vectors; and
warning if the physical and mental classification is regarded as abnormality.

24. The monitor method of claim 23, further comprising the step is of:
updating the remote physical and mental database with the warning data in a specific period.

25. The monitor method of claim 24, wherein the update proceeds in an off-line manner.

26. The monitor method of claim 23, wherein the step of calculating the physical and mental classification comprises the step of:
performing a matrix multiplication between the physical and mental weighting factors and characteristic vectors and an addition by a constant to obtain three physical and mental classifications W₀, W₁ and W₂.

27. The monitor method of claim 26, further comprising the steps of:
adding neutral and low physical and mental indices by one if W₀ is smaller or equal to zero;
adding neutral and high physical and mental indices by one if W₁ is smaller or equal to zero;
adding high and low physical and mental indices by one if W₂ is smaller or equal to zero; and
determining the physical and mental index having the greatest value as the physical and mental status.

28. A monitor method, comprising the steps of:
generating physical and mental weighting factors of a specific user from a physical and mental database of a remote computer;
obtaining physical and mental characteristic vectors with a portable device; and
performing a physical and mental classification with the physical and mental weighting factors and characteristic vectors.

29. The monitor method of claim 28, wherein the step of performing the physical and mental classification of the specific user comprises the step of:
performing a matrix multiplication between the physical and mental weighting factors and characteristic vectors and an addition by a constant to obtain three physical and mental classifications W₀, W₁, and W₂.

30. The monitor method of claim 29, further comprising the steps of:
adding neutral and low physical and mental indices by one if W₀ is smaller or equal to zero;
adding neutral and high physical and mental indices by one if W₁ is smaller or equal to zero;
adding high and low physical and mental indices by one if W₂ is smaller or equal to zero; and
determining the physical and mental index having the greatest value as the physical and mental status.
